(19) United States
(12) Patent Application Publication
(10) Pub. No.: US 2024/0315182 A1
(43) Pub. Date: Sep. 26, 2024

(54) HIGH EFFICIENCY PLANTER SYSTEM AND METHOD

(71) Applicant: MEB Holdings LLC, Eugene, OR (US)

(72) Inventor: Daniel Naum, Eugene, OR (US)

(73) Assignee: MEB Holdings LLC, Eugene, OR (US)

(21) Appl. No.: 18/581,367

(22) Filed: Feb. 19, 2024

Related U.S. Application Data
(60) Provisional application No. 63/446,885, filed on Feb. 19, 2023.

(51) Int. Cl. A01G 27/02; A01G 9/02

(52) U.S. Cl. CPC A01G 27/02; A01G 9/028

(57) ABSTRACT

Embodiments include an apparatus and method for a planter configured to receive and grow a plant having a container with a main body and a base coupled to the bottom of the main body. The main body and base define an interior space and is configured to receive and hold a grow medium. The main body has internal and external surfaces in which the internal surface faces the interior space of the container. The external surface of the main body includes a plurality of body ribs and channels where each body rib includes a plurality of vented openings. The base includes a conical portion located at a substantially central location and a plurality of base ribs extending radially from an outer surface of the conical portion toward the interior surface of the main body. Each portion between adjacent base ribs includes a plurality of vented openings.

### RELATED APPLICATIONS

This application claims priority to U.S. Provisional Application No. 63/446,885 filed Feb. 19, 2023, the contents of which are incorporated herein by reference.

### FIELD

This disclosure relates to a design for a planter that provides a system and method for facilitating highly efficient growth of plants and efficient use of water and nutrients.

### DESCRIPTION OF THE RELATED ART

Planters have been used for a variety of purposes in regard to the growth of plants including for initial growth, for transport, for indoor growth, as well as other purposes. Typical plants grown in planters include, for example, tomato, cucumber, and cabbage plants. Conventional planters usually have a substantially cylindrical shape configured to hold soil or other grow medium. A plant is planted in the grow medium and provide with water or other liquid nutrient and exposure to light, whether natural or artificial, to help the plant grow.

Conventional planters suffer from several drawbacks. As a plant grows in a conventional planter, the roots are typically concentrated near the center of the planter with the roots usually circulating around the planter. When the plant is removed at the end of its life, the density of the roots is comparatively small. With the comparatively small density of roots, the plant does not receive nutrients for growth as efficiently as it would with a greater density of roots.

With a less than efficient system for feeding nutrients to the plant due to the comparatively small density of roots, conventional planters also require significant volumes of water to grow the plant. The watering of the plant in the conventional planter typically uses a hose to provide the water to the plant, which results in the use of large volumes of water and random distribution of water to the grow medium and plant. Such large volumes of water and random distribution result in less than efficient use of water and less than efficient growth of the plant. It would be desirable to have a planter capable of growing as large a plant as possible having greater root development and more efficient use of water and grow medium.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 shows an exploded version of a planter according to an embodiment;

FIG. 2 shows a fully assembled planter according to an embodiment;

FIGS. 3A-3D show perspective view of a container for a planter according to an embodiment;

FIGS. 4A-4E show cutout perspective views of a base of container and exemplary structure and arrangements of an air cone according to an embodiment;

FIGS. 5A-5E show plan and perspective examples of a lid according to an embodiment;

FIG. 6 shows an example of a moisture meter according to an embodiment;

FIG. 7 shows an example of a system including an array of planters according to an embodiment;

FIGS. 8A and 8B show perspective views of a liquid distribution pipe according to an embodiment; and

FIG. 9 is an example of a liner that can be used to line an interior surface of a container according to an embodiment.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein and may be practiced using one or more implementations. In one or more instances, structures and components are shown in simplified form in order to avoid obscuring the concepts of the subject technology.

In the drawings referenced herein, like reference numerals designate identical or corresponding parts throughout the several views or embodiments.

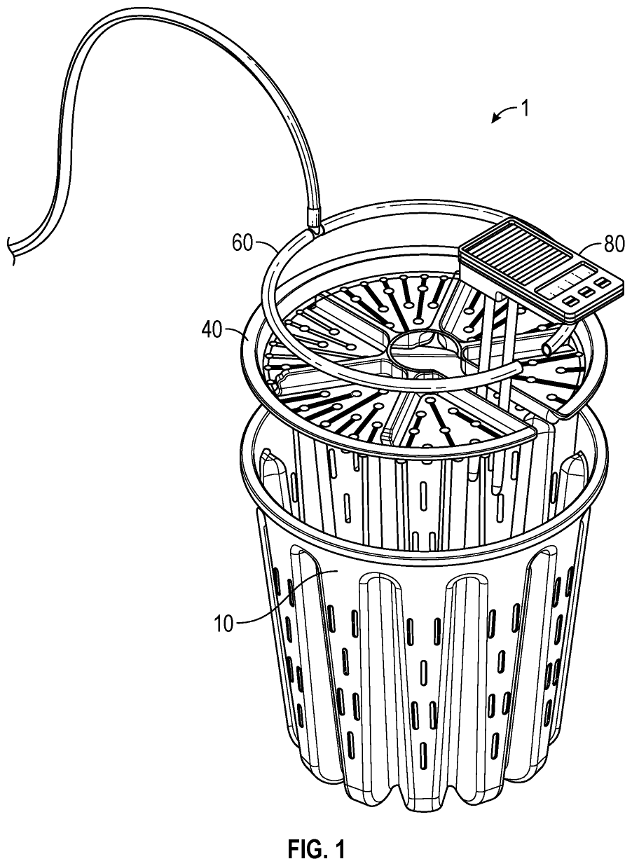

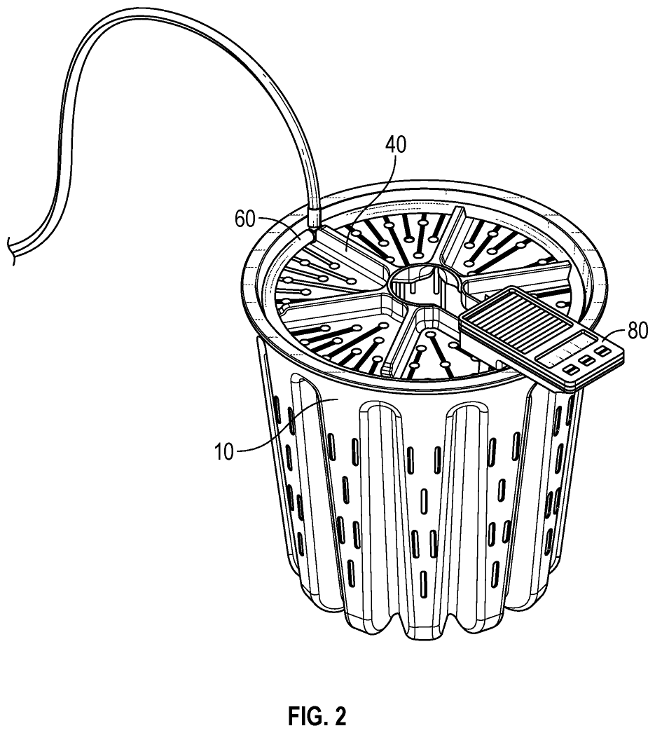

FIG. 1 shows an exploded version of a planter according to an embodiment, and FIG. 2 shows the same planter when fully assembled. As shown in FIG. 1, a planter 1 can include a container 10, a lid 40, liquid distribution pipe 60, a moisture meter 80, and a liner (not shown). Container 10 is a high efficiency vented container that includes internal surfaces to maximize surface areas including ribs that can prevent circulating roots as well as air channels to help maximize root volume. The liner is a removable insert made of biodegradable materials and/or non-biodegradable materials that can be configured to line all of portions of the interior surfaces of container 10. Lid 40 can be configured to fit over a top surface of container 10 and to provide an even distribution of liquid solution or water using channels and drip cones as well as small reservoirs on a top surface of lid 40. Liquid distribution pipe 60 can be configured to fit tightly to the top surface of lid 40 to provide liquid to the reservoirs, channels, and drip cones of lid 40, and can be made from a variety of different materials such as recycled tires or laser drilled out of solid tubing. Moisture meter 80, in addition to measuring moisture of grow medium in container 10, can also display temperature and soil pH and can be configured to transmit using wireless signaling (e.g., RF) to a general controller that can control one or more planters in regard to moisture and other parameters. Container 10 and lid 40 can be made, for example, from a hard plastic or other materials capable of maintaining rigidity sufficient to hold grow medium, a plant, and liquid materials and being completely or substantially water impermeable.

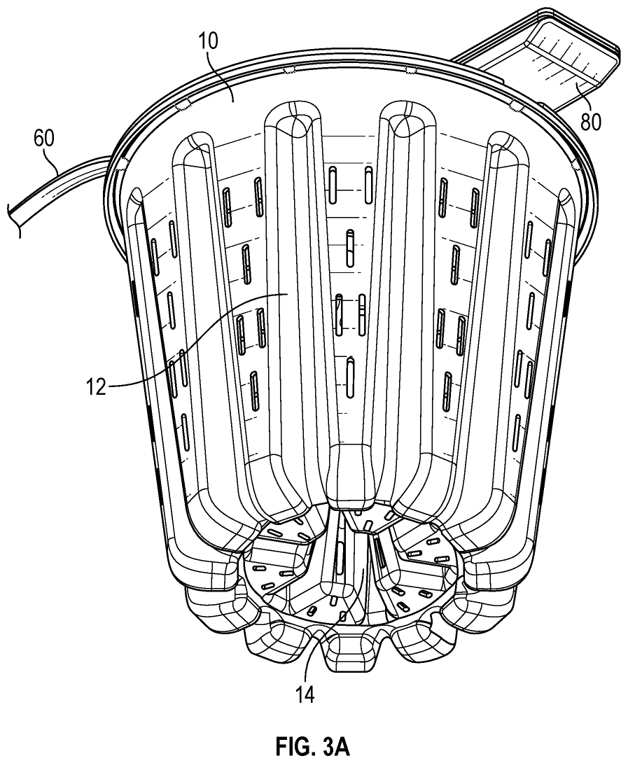

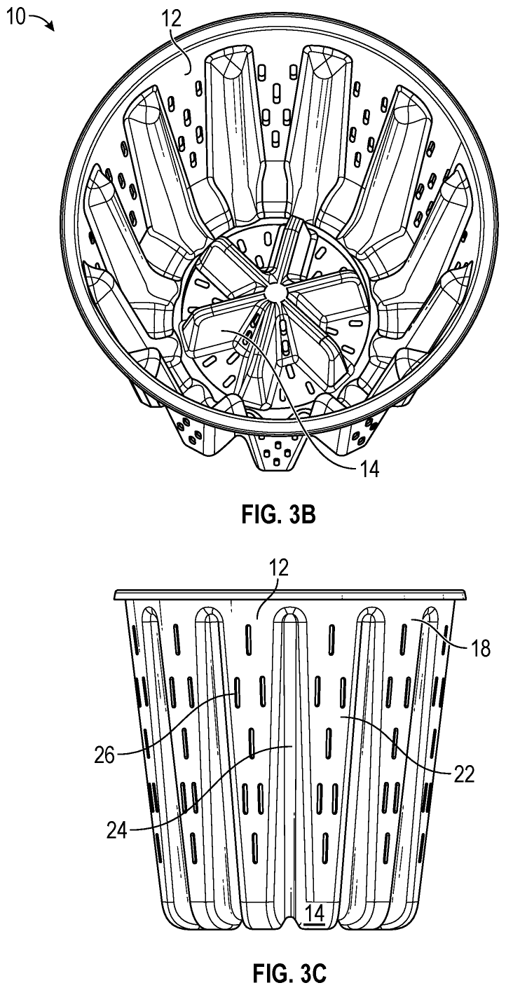

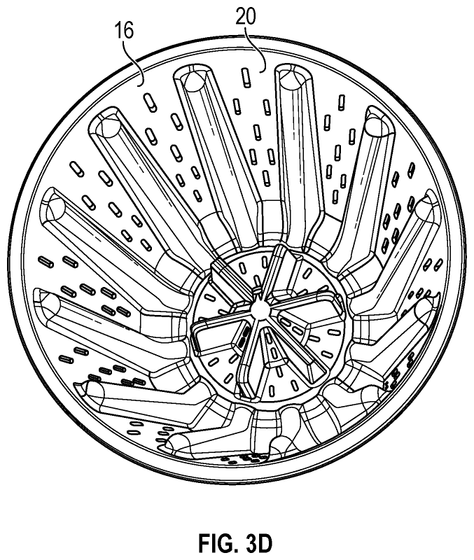

FIGS. 3A-3D show perspective view of a container for a planter according to an embodiment. As shown in these figures, container 10 includes a main body 12 and a base 14. Main body 12 and base 14 can be a unified piece or can be separate pieces that couple together to form container 10. Container 10 also includes an interior surface 16 and an exterior surface 18, the interior surface 16 defining an interior space 20 in which container 10 can hold a grow medium, such as soil or other materials as are known to facilitate plant growth.

Exterior surface 18 of main body 12 can include a plurality of ribs 22 and a plurality of channels 24. Ribs 22 and channels 24 can be aligned vertically on exterior surface 18. As shown in FIGS. 3A-3D, each rib 22 is positioned between adjacent pairs of respective channels 24, and each channel 24 is positioned between adjacent pairs of respective ribs 22. In the configuration of FIGS. 3A-3D, main body 12 includes twelve ribs 22 and twelve channels 24, but main body 12 can include more or fewer ribs 22 and channels 24 in different embodiments. In addition, the widths and lengths of ribs 22 and channels 24 can vary such that ribs 22 can be wider than channels 24 and vise versa. The widths can also vary along the lengths, such as shown in FIGS. 3A and 3C, in which ribs 22 are wider at the top and narrow toward the bottom while channels 24 are narrower at the top and widen toward the bottom. For interior surface 16, ribs 22 and channels 24 on exterior surface 18 appear as the inverse, i.e., ribs 22 look like channels on interior surface 16, and channels 24 look like ribs on interior surface 16.

Each rib 22 can include one or more vents 26 that pass through exterior surface 18 to interior surface 16 of main body 12. As shown in FIGS. 3A-3D, the number of vents 26 included in each rib 22 is six or seven, but it should be understood that each rib 22 can include more or fewer vents than are shown. The arrangement of vents 26 is shown as alternating single and pairs of vents along a length of each rib 22, but other arrangements of vents 26 can also be used depending on the size and shape of each vent 26 and the size and shape of each rib 22. Each vent 26 is shown as having a uniform rectangular shape with a shorter edge along its width and a longer edge along its length. While shown with uniform rectangular shapes, vents 26 can have different shapes including square, circular, irregular, other quadrilateral, or other shapes as are known. In addition, vents 26 on a rib 22 can have different shapes than other vents 26 on the same rib 22. Vents 26 are preferably configured to enable air flow into interior space 20 of container 10. The air flow provided by vents 26 can provide advantages to the growth of a plant planted to grow in planter 1 as further explained herein.

Container 10, as shown in FIGS. 3A-3D, has a general tapering shape from top to bottom with a top of container 10 being wider than a bottom of container 10. Container 10 is also shown as having a generally cylindrical shape with a generally circular cross-section, but this shape is exemplary only. Container 10 can also have other shapes such as a uniform width from top to bottom, having sides instead of a substantially round or circular form, or tapering from bottom to top. Container 10 can also be configured to have different sizes and different depths depending on the type of plant to be planted in planter 1.

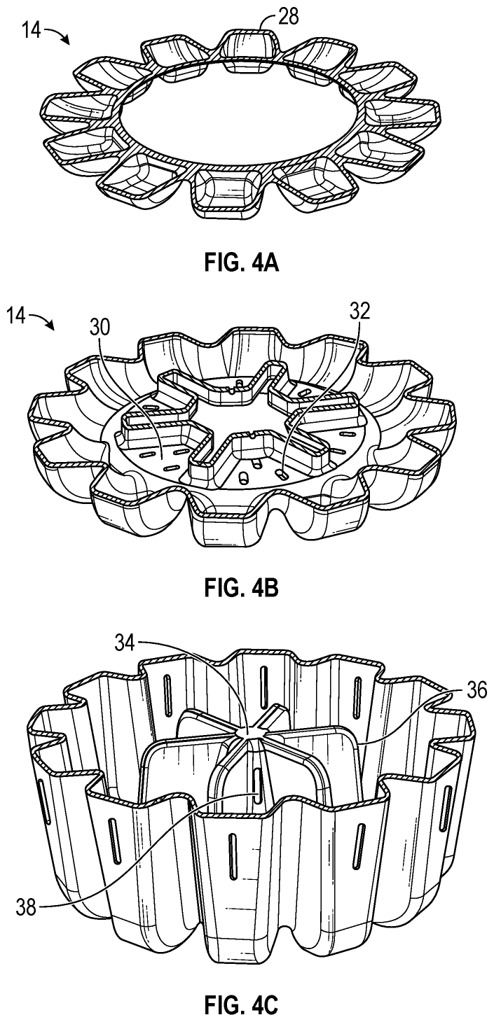

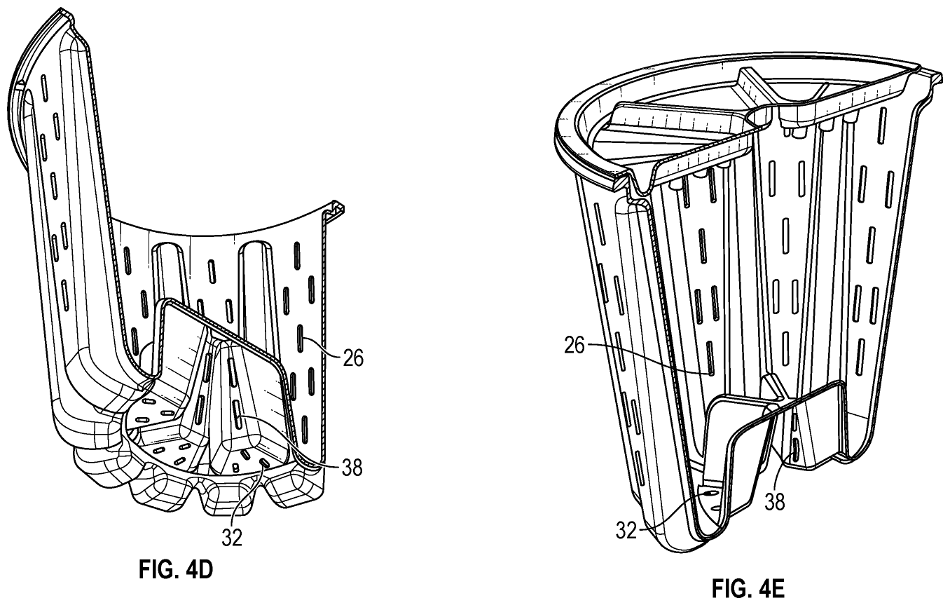

FIGS. 4A-4E show cutout perspective views of the base 14 of container 10 according to an embodiment. As shown in FIG. 4A, a plurality of reservoirs 28 are positioned adjacent to each other along an outer perimeter of base 14. Reservoirs 28 are each configured to hold a small amount of water at the base that can be used to provide additional moisture to the surface of the grow medium. As explained further herein, a biodegradable or non-biodegradable insert can provide this additional moisture to the surface of the grow medium through a wicking of the reservoirs 28. On the exterior side of base 14, reservoirs 28 can function as feet to provide an elevation for planter 1. This elevation allows for air flow entry under planter 1 through an air cone 34 in the center of base 14, described in more detail herein.

As shown in FIG. 4B, base 14 includes a base surface 30 and vents 32. Because reservoirs 28 function as feet to provide an elevation to planter 1, base surface 30 and vents 32 are elevated. This elevation of base surface 30 and vents 32 can be seen, for example, in FIGS. 4E and 4D, which show cutout perspective views of container 10 with and without lid 40 according to an embodiment. With this elevation, and with the space provided between adjacent reservoirs 28 (as seen, for example, in FIGS. 4C-4E), enables air flow entry into planter 1 via vents 32. Base surface 30 is separated into six different sections by ribs 36 of an air cone 34, such as shown in FIGS. 4B and 4C. The number of different sections can be more or fewer, depending on the number of ribs 36. In addition, the size of each section of base surface 36 can be uniform, such as shown in FIGS. 4B and 4D, or can be of differing sizes depending on the arrangement of ribs 36 on air cone 34.

As shown in FIGS. 4B and 4D, the number of vents 32 included in second base surface 30 is three, but it should be understood that each section of base surface 30 can include more or fewer vents 32 than are shown. The arrangement of vents 32 is shown with a triangular positioning, generally in accordance with the shape of each section of base surface 30, but other arrangements of vents 32 can also be used depending on the size and shape of each vent 32 and the size and shape of each section of base surface 30. Each vent 32 is shown as having a uniform rectangular shape with the longer edge substantially parallel to a radial direction from a center of base 12. While shown with uniform rectangular shapes, vents 32 can have different shapes including square, circular, irregular, other quadrilateral, or other shapes as are known. In addition, vents 32 on a particular section of base surface 30 can have different shapes than other vents 32 on the same section of base surface 30. Vents 32 are preferably configured to enable air flow into interior space 20 of container 10. The air flow provided by vents 32 can provide advantages to the growth of a plant planted to grow in planter 1 as further explained herein.

FIGS. 4C-4E show exemplary structure and arrangements of air cone 34 and ribs 36 according to an embodiment. As shown in these figures, air cone 34 rises from base surface 30 and has a substantially conical shape with a narrowing or tapering from a base of air cone 34 to a top of air cone 34. The top of air cone 34 has a flat surface, but it can alternatively rise to a point, have a rounded, dome-like surface, or other shape as desired. Ribs 36 extend radially out from an outer surface of air cone 36 (which is inside container 10) and toward the interior surface 16 of container 10. Each rib 36 has substantially flat opposing surfaces, can be formed as a solid piece of plastic or other rigid material, or can be hollow between the flat opposing surfaces. Ribs 36 preferably extend to an outer perimeter edge of base surface 30 without contacting interior surface 16 of container 10 and can be aligned with an interior surface of rib 22, channel 24, or a mixture of both. As shown in FIG. 4C, planter 1 includes six ribs 36, but it should be understood that more or fewer ribs 36 can be included. Ribs 36, in addition to maximizing surface area within planter 1, create an “air zone envelope” in conjunction with liner 90 and direct the bottom roots of a plant in an array pattern around air cone 34, which provides better root distribution at the base of planter 1.

As shown in FIGS. 3B, 3C, and 4C, air cone 34 includes vents 38 on the vertical walls of air cone 34 that are shown between adjacent pairs of ribs 36. The number of vents 38 included on each vertical wall portion of air cone 34 between adjacent pairs of ribs 36 is two, but it should be understood that each portion can include more or fewer vents 38 than are shown. The arrangement of vents 38 is shown as being aligned vertically, generally in accordance with the shape of each vertical wall portion, but other arrangements of vents 38 can also be used depending on the size and shape of each vent 38 and the size and shape of each vertical wall section. Each vent 38 is shown as having a uniform rectangular shape with the longer edge substantially aligned in a vertical direction. While shown with uniform rectangular shapes, vents 38 can have different shapes including square, circular, irregular, other quadrilateral, or other shapes as are known. In addition, vents 38 on a particular vertical wall section can have different shapes than other vents 38 on the same vertical wall section. Vents 38 are preferably configured to enable air flow into interior space 20 of container 10. The air flow provided by vents 38 can provide advantages to the growth of a plant planted to grow in planter 1 as further explained herein.

The interior surfaces and walls of planter 1 can prevent moisture/water evaporation while simultaneously allowing for a limited amount of air to enter planter 1 through the various vents to create the “air zone envelope” in conjunction with liner 90 all around the grow medium and the roots of a plant that is planted in planter 1. In addition, the interior surfaces and walls of planter 1 can help to maintain moisture/water inside planter 1, which reduces water consumption. In contrast, standard fabric pots have substantially high evaporation rates, thereby causing rapid moisture/water evaporation and increasing water consumption substantially. Fabric pots also have poor structural integrity.

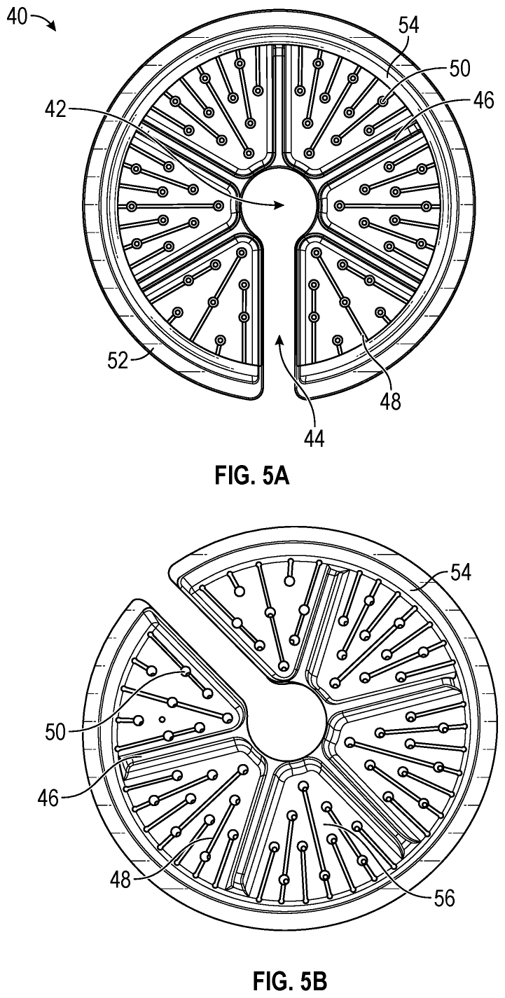

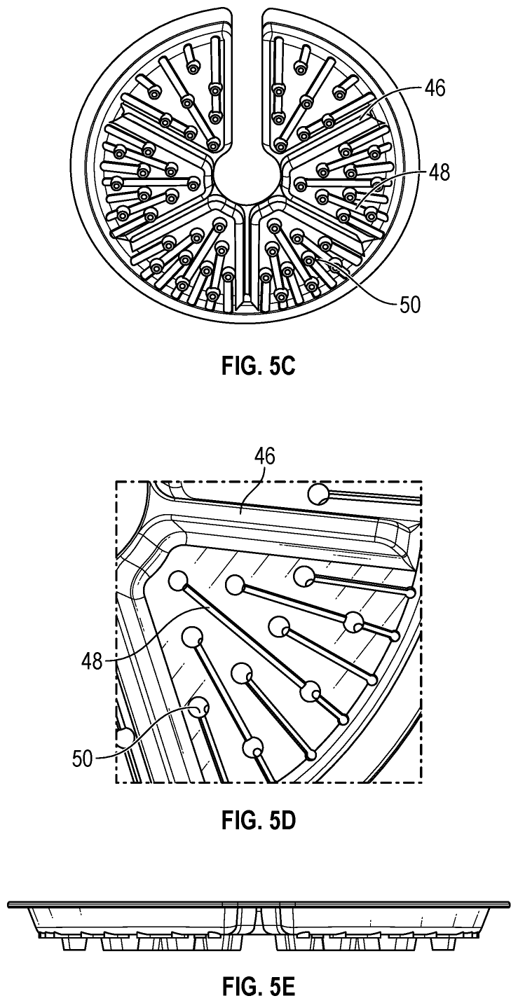

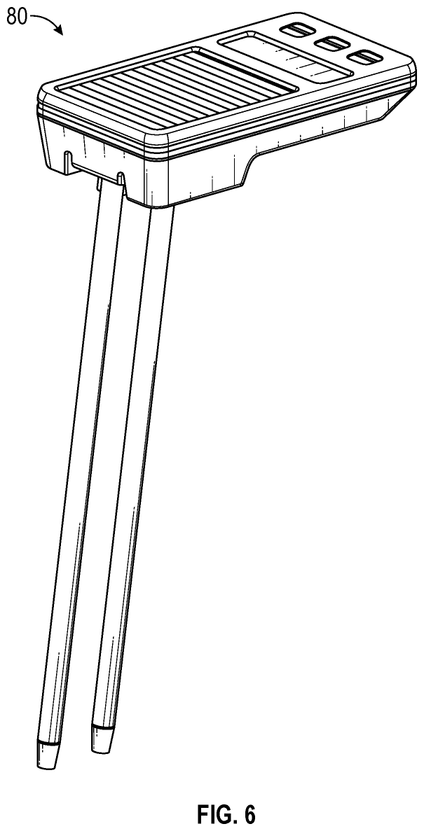

FIGS. 5A-5D show plan and perspective examples of lid 40 according to an embodiment. As shown in FIGS. 5A-5D, lid 40 is preferably shaped to fit and conform to the shape of the top of container 10. Although shown to be round, lid 40 can have other shapes including, for example, rectangular, square, or other design in accordance with the shape of the top of container 10. Lid 40 can include a central hole 42 from where the center part of a plant grows that has been planted in planter 1 and a channel 44 that makes it possible to slide lid 40 over the base of the plant.

Lid 40 can also include ribs 46 that extend radially from central hole 40 toward an outer perimeter wall 52 of lid 40. Ribs 46 can be configured to define a plurality of reservoirs 56 that can collect water or other liquids. As shown in FIGS. 5A and 5B, lid 40 includes six ribs 46, with one rib 46 divided in half by channel 44, defining six reservoirs 56. Although shown with six ribs 46 and reservoirs 56, the number of ribs 46 and reservoirs 56 can be more or fewer than six each. In addition, although shown as evenly positioned on the top surface of lid 40, ribs 46 can be arranged such that reservoirs 56 are substantially equally sized or having different sizes.

On a bottom surface of reservoirs 56, lid 40 can also include an arrayed system of channels 48 with each channel having one or more drip cones 50 including a drip cone 50 at the end of each channel 48 as well as distributed over the length of channel 48. Similar to ribs 46, channels 48 are arrayed radially from central hole 40. Each channel 48 is cut out from the bottom surface of reservoirs 56 and configured to channel water or liquids in reservoirs 56 to drip cones 50. As shown more clearly in FIGS. 5C and 5D, drip cones 50 can extend below a bottom surface of lid 40. With drip cones 50 arranged along different positions in channels 48, drip cones 50 can provide water or other liquids to a grow medium and a plant planted in planter 1 along distributed positions of lid 40 and thus enable a more even distribution of water or liquids to the grow medium and plant than would be provided by one or just a few positions for providing water or liquids.

Lid 40 can also include a channel 54 around an outer perimeter portion of lid 40. Channel 54 lies within an inner surface of outer perimeter wall 52. Ribs 46 can be configured to end adjacent to or at channel 54. Channel 54 extends downwardly from a bottom surface of lid 40 and is preferably configured to contact or engage interior surface 16 of main body 12 when lid 40 is placed on container 10. Channel 54 can also be configured to receive and hold liquid distribution pipe 60. When channel 54 holds liquid distribution pipe 60, liquid distribution pipe 60 can deliver liquids like water to reservoirs 56. Liquid distribution pipe 60 preferably includes multiple outlets or holes that enable liquid to be expelled from liquid distribution pipe 60 to reservoirs 56.

FIG. 6 shows an example of a moisture meter 80 according to an embodiment. As explained previously, moisture meter 80 can be configured to measure a moisture level of grow medium in container 10, a temperature, and pH of the grow medium. In addition, moisture meter 80 can be configured to transmit the data it measures and collects using wireless signaling such as RF, WiFi, Bluetooth, or other wireless transmission systems as are known. Moisture meter 80 can also incorporate circuitry for self-charging to avoid a need for replacing batteries. Moisture meter 80 can work with ambient light, both indoors and outdoors. The incorporated circuitry can be configured to absorb light from the ambient environment sufficient to charge moisture meter 80 even in low light levels.

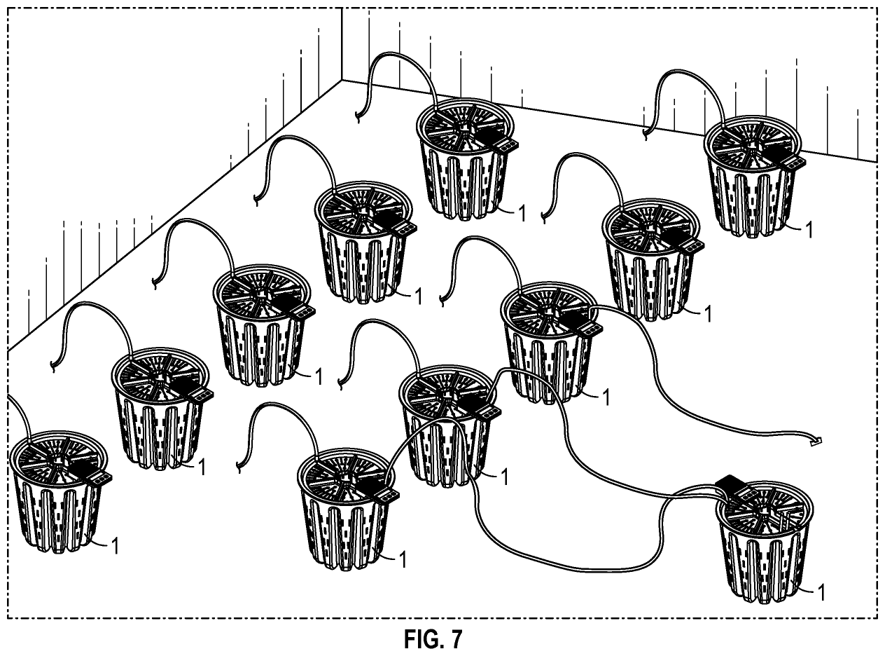

The data collected by moisture meter 80 can be transmitted to a general controller that can individually control moisture levels and other parameters with respect to each planter 1, such as shown in FIG. 7. In the exemplary embodiment of FIG. 7, the displayed system includes an array of planters 1, with each having a respective moisture meter 80. Using the data received from moisture meter 80, the general controller can be configured to control an ambient temperature, to control distribution of liquids from liquid distribution pipe 60 at each planter 1, and display or send information to an operator about any issues with any of the planters 1, such as too high or too low a pH level.

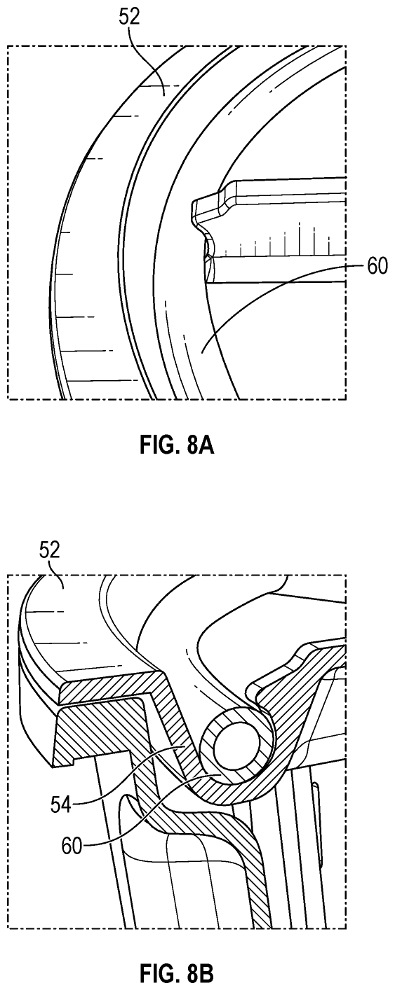

FIGS. 8A and 8B show perspective views of liquid distribution pipe 60 according to an embodiment. As shown in FIGS. 8A and 8B, liquid distribution pipe 60 fits within channel 54 of lid 40. In addition, an end of each rib 46 can include a curved portion that substantially conforms to the outer circumferential shape of liquid distribution pipe 60 to help retain liquid distribution pipe 60 within channel 54 of lid 40. FIG. 8B also shows how outer perimeter wall 52 of lid 40 can be formed to sit on and fit into a top surface of container 10 to form a substantially enclosed container.

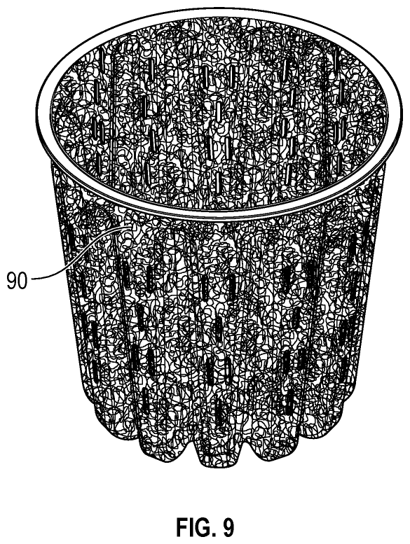

FIG. 9 is an example of a liner or insert that can be used to line an interior surface of container 10 according to an embodiment. As shown in FIG. 9, a liner 90 can be shaped to conform substantially to an internal surface of container 10. As shown in FIG. 9, liner 90 covers the entire internal surface of container 10. In other embodiments, liner 90 can be shaped to cover only interior surface 16 of main body 12 (thus leaving a top surface of base 14 uncovered), to cover interior surface 16 of main body 12 and only a portion of top surface of base 14, or to cover only a portion of interior surface 16 of main body 12.

Liner 90 can be made out of biodegradable materials such as hemp, cocoa fiber, recycled cardboard, and/or other natural materials. These biodegradable materials can be bound together to form liner 90 using, for example, natural latex rubber. Natural latex rubber does not form a completely water-tight film but can substantially prevent transmission of liquids like water. Natural latex rubbers also have porous-like qualities that enable air to flow through vents 26, 32, and 38 to reach the roots of a plant planted in planter 1. When placed in container 10, the latex adhesive of liner 90 preferably faces the internal surface of container 10. Liner 90 can alternatively be formed with non-biodegradable liners such as polyester, felt-like materials, acrylics, other polymers, or other non-woven materials. A thickness of liner is preferably between 1/16 and ¼ inch thick. Liner 90 can also be reusable, and when not biodegradable is preferably recyclable. Liner 90, whether biodegradable or not, is preferably a soft insert that when placed inside container 10 will tend to conform within a specific range to the inside structure of container 10.

Liner 90 can also be formed as a combination of biodegradable and non-biodegradable materials. In addition, liner 90 can be formed as a mix of polymer(s) and slow-release plant nutrients, such as fertilizers, or formed with slow-release plant nutrients without polymer(s). Liner 90 can be formed as biodegradable materials sandwiched between non-biodegradable materials or vice versa. In one embodiment, liner 90 can be formed in a sandwich-like construction that is porous and includes recycled paper and/or other materials or combination of materials on two outer surfaces and a center part having super absorbing polymer powder or crystals along with slow-release plant nutrients. The slow-release plant nutrients can contain macronutrients like nitrogen, potassium, and phosphorus, a ‘secondary macronutrient’ like calcium, magnesium, and sulfur, and/or micronutrients such as boron, chlorine, copper, iron, manganese, molybdenum, and zinc. Custom types of plant specific slow-release plant nutrients can be formulated. This type of liner 90 can contain, for example, polymers having sodium atoms such as sodium polyacrylate. Such polymers are capable of holding more than 100 times its weight in water. When tested, sodium polyacrylate was shown to be capable of holding 343 times its weight in water. With this construction, liner 90 can provide higher moisture inside planter 1.

Material for liner 90 is preferably selected based on its diffusivity rate (cm²/s) properties. Desirable characteristics for the material for liner 90 include, for example, vertical moisture wicking ability, diffusivity ability, evaporation ability, and mechanical and structural suitability. As noted previously, a combination of two types of material can be used to form liner 90 with a sandwich-like construction and thus take advantage of desirably characteristics of both types of materials. The material for liner 90 also preferably has specific characteristics for facilitating air intake by the vents in planter 1.

Planter 1 is designed to increase internal volume by using non-perforated surfaces that server to terminate root growth and correspondingly increase the mass of the plant and its roots. As explained previously, planter 1 can be made in different shapes including round, square, rectangular, or other shape. Base 14 of planter 1 includes air cone 34 and ribs 36 that provide flat surfaces at which roots of the plant can develop. Vents 32 provide a uniform air flow that, in conjunction these additional flat surfaces, can help to prevent roots from circulating. In addition, vents 36 allow airflow to continue upwards through planter 1 and similarly can help to prevent roots from circulating while avoiding uneven root accumulations in planter 1. Tests performed using planter 1 have demonstrated that plants grown in planter 1 are able to develop a spongelike mass where the grow medium used to grow the plant essentially becomes part of the root system, which can provide even more surface area for the plant to absorb nutrients and water.

In operation, planter 1 can be used as a complete or partial system. In a complete system, planter 1 can include container 10, lid 40, liner, and optional moisture meter 80. Alternatively, planter 1 can be used with container 10 and liner but without lid 40 or moisture meter 80. In another alternative, planter 1 can use container 10 only

When a plant is planted in a grow medium in planter 1, planter 1 can provide a water-minimizing growth container for plants, as well as provide accelerated root development that in turn produces a bigger plant in a smaller surface area. Planter 1 can provide these benefits by providing large internal root growth plates and surfaces where the roots terminate once they hit that particular surface. Planter 1 also provides a balance between internal moisture due to the liner as well as the air flow through planter 1 through the use of arrayed shafts on the outer surface of planter 1 as well as air cone 34 to provide additional air. The liner also provides a balance between the amount of moisture and the amount of air in planter 1. By keeping the balance between moisture and air relatively constant, planter 1 can avoid too much moisture or too much air and eliminate root rot and circling roots that typically occur in other planters that lack the venting and line of planter 1.

During growth, the tap root of the plant typically grows downward and laterally and will continue to grow until reaching the beginning of an air layer close to the liner. As the roots continue to grow past the first air layer reached, the roots are subjected to a drying effect due to the air flow surrounding planter 1. The same drying effect is accomplished by air cone 34 in base 14 and other strategically located vents including vents 26, 32, and 38. The root ends can be terminated by drying the tips as a result of the air flow. After the root ends are terminated, other roots are developed that stretch and fill any remaining void inside planter 1. These other roots continue to grow until reaching edges, the base, or other surfaces of planter 1, like the surfaces of ribs 36. At that point, the process repeats, and other lateral roots develop from those roots. As a result of this growth process in planter 1, the inside of planter 1 can become a very thick, dense mat filled with roots that appear like a sponge. This spongelike mass can absorb many more nutrients and water for the plant in planter 1 while containing only a small amount of grow medium (e.g., soil) as compared to conventional planters that need to be several times larger than planter 1 to be able to grow similar sized plants.

Tests conducted on planter 1 have shown that the increased surface area in its configuration allows for development of additional roots that normally would not have developed if the internal surface of planter 1 was smooth. The increased number of roots and the ability of those roots to branch out and create a mat-like, sponge-like surface, in combination with the control of moisture and air within planter 1, makes it possible to achieve larger plants without using larger containers, using a reduced quantity of soil, and using a lower amount of water/nutrient solutions.

The size of planter 1 can vary to accommodate different types of plants that have different sizes. In an exemplary implementation, planter 1 can be sized to be 22 cm x. 22 cm. To be able to scale planter up or down, it is preferable to calculate the total surface area of all the surfaces in planter 1. Total vertical surface area can essentially be based on calculating the internal surface area of a cylinder approximately corresponding to the internal surface area the main body 12. That surface area is reduced by area of the distributed vents (e.g., vents 26) on the internal surface of main body 12, where the reduction corresponds to the area of each opening (e.g., 2.0 cm x. 0.25 cm) multiplied by the number of vents in the vertical surface. The ratio of total surface area to total vented area on the vertical surface preferably lies within a range of 1.8 to 3%, but this range can be adjusted up or down as desired.

Base 14 of planter 1 can have a diameter, for example, of 22 cm, and a surface area of base 14. Similar to the ratio of the internal surface of main body to the total vented area, a ratio can be calculated based on the total surface area of base 14 (e.g., area of a circle with diameter 22 cm) to the total vented area. For that ratio, a preferable ratio is 3.94%, within a range of 3.9% to 5%, or other range as desired. Using these desired ratios and a desired volume of planter 1, it is possible to calculate the arrangement of surface area to vented area for the vertical portion (e.g., main body 12) and the base portion (e.g., base 14) of planter 1.

Various embodiments of the invention are contemplated in addition to those disclosed hereinabove. The above-described embodiments should be considered as examples of the present invention, rather than as limiting the scope of the invention. In addition to the foregoing embodiments of the invention, review of the detailed description and accompanying drawings will show that there are other embodiments of the present invention. Accordingly, many combinations, permutations, variations, and modifications of the foregoing embodiments of the present invention not set forth explicitly herein will nevertheless fall within the scope of the present invention.

What is claimed is:

1. A planter configured to receive and grow a plant, comprising:
a container having a main body and a base coupled to the bottom of the main body, the main body and base defining an interior space of the container with an opening at a top of the container, the container configured to receive and hold a grow medium for facilitating growth of a plant when planted in the grow medium,
the main body having an external surface and an internal surface in which the internal surface faces the interior space of the container, the external surface of the main body including a plurality of alternating main body ribs and main body channels, such that each main body rib is between a pair of adjacent main body channels and each main body channel is between a pair of adjacent main body ribs, each main body rib including a plurality of vented openings exposing the interior space of the container, and
the base having an external surface and an internal surface in which the internal surface faces the interior space of the container, the base including a conical portion located at a substantially central location of the base, the conical portion extending into the interior space of the container from a base surface of the base, the base further including a plurality of base ribs extending radially from an outer surface of the conical portion toward the interior surface of the main body, each portion of the base surface between adjacent base ribs including a plurality of vented openings exposing the interior space of the container.

2. A planter according to claim 1, wherein the base includes a plurality of feet located adjacent to an outer perimeter of the base, each foot of the base configured to be a reservoir for holding a liquid.

3. A planter according to claim 1, wherein each external surface of the conical portion located between adjacent base ribs includes at least one vented opening exposing the interior space of the container.

4. A planter according to claim 1, wherein each base rib has substantially flat opposing surfaces extending radially from the conical portion.

5. A planter according to claim 1, further comprising a lid having a top surface and a bottom surface and an outer perimeter edge, wherein the lid is configured to fit on the main body at a top of the container.

6. A planter according to claim 5, wherein the lid includes a central opening configured to surround a center part of the plant and an open channel extending from the central opening to a perimeter edge of the lid configured to enable the lid to slide over a base of the plant.

7. A planter according to claim 6, wherein the lid includes a plurality of lid surface ribs extending radially from the central opening to an outer perimeter edge of the lid, each pair of adjacent lid surface ribs defining a reservoir on the top surface of the lid, and
wherein each reservoir includes a lower surface in which a plurality of channels is defined, each channel extending below the top surface of the lid.

8. A planter according to claim 7, wherein each channel includes one or more drip cones extending below the bottom surface of the lid, each drip cone having an opening configured to enable a liquid to drip down from a respective channel into the interior space of the container.

9. A planter according to claim 7, further comprising tubing positioned between the outer perimeter edge of the lid and ends of the lid surface ribs, the tubing including a plurality of openings to feed a liquid to respective reservoirs.

10. A planter according to claim 1, further comprising a liner covering at least the internal surface of the main body, the liner being formed of a biodegradable material and configured to enable air to pass through the vented openings to the interior space of the container.

11. A method for forming a planter configured to receive and grow a plant, comprising:
forming a container to have a main body and a base coupled to the bottom of the main body, the main body and base defining an interior space of the container with an opening at a top of the container, the container configured to receive and hold a grow medium for facilitating growth of a plant when planted in the grow medium,
forming the main body to have an external surface and an internal surface in which the internal surface faces the interior space of the container, the external surface of the main body including a plurality of alternating main body ribs and main body channels, such that each main body rib is between a pair of adjacent main body channels and each main body channel is between a pair of adjacent main body ribs, each main body rib including a plurality of vented openings exposing the interior space of the container, and
forming the base to have an external surface and an internal surface in which the internal surface faces the interior space of the container, the base including a conical portion located at a substantially central location of the base, the conical portion extending into the interior space of the container from a base surface of the base, the base further including a plurality of base ribs extending radially from an outer surface of the conical portion toward the interior surface of the main body, each portion of the base surface between adjacent base ribs including a plurality of vented openings exposing the interior space of the container.

12. A method according to claim 11, wherein the method further comprises forming the base with a plurality of feet located adjacent to an outer perimeter of the base, each foot of the base configured to be a reservoir for holding a liquid.

13. A method according to claim 11, wherein the method further comprises forming, at each external surface of the conical portion located between adjacent base ribs, at least one vented opening exposing the interior space of the container.

14. A method according to claim 11, wherein the method further comprises forming each base rib with substantially flat opposing surfaces extending radially from the conical portion.

15. A method according to claim 11, wherein the method further comprises forming a lid having a top surface and a bottom surface and an outer perimeter edge, wherein the lid is configured to fit on the main body at a top of the container.

16. A method according to claim 15, wherein the method further comprises forming a central opening in the lid configured to surround a center part of the plant and an open channel extending from the central opening to a perimeter edge of the lid configured to enable the lid to slide over a base of the plant.

17. A method according to claim 16, wherein the method further comprises forming a plurality of lid surface ribs in the lid extending radially from the central opening to an outer perimeter edge of the lid, each pair of adjacent lid surface ribs defining a reservoir on the top surface of the lid, and
forming each reservoir to have a lower surface in which a plurality of channels is defined, each channel extending below the top surface of the lid.

18. A method according to claim 17, wherein the method further comprises forming each channel to have one or more drip cones extending below the bottom surface of the lid, each drip cone having an opening configured to enable a liquid to drip down from a respective channel into the interior space of the container.

19. A method according to claim 11, wherein the method further comprises forming a tubing positioned between the outer perimeter edge of the lid and ends of the lid surface ribs, the tubing including a plurality of openings to feed a liquid to respective reservoirs.

20. A method according to claim 11, wherein the method further comprises forming a liner covering at least the internal surface of the main body, the liner being formed of a biodegradable material and configured to enable air to pass through the vented openings to the interior space of the container.
